(19) United States
(12) Patent Application Publication
(10) Pub. No.: US 2011/0255384 A1
(43) Pub. Date: Oct. 20, 2011

(54) BOOKMARKING DIGITAL CONTENT ON BLU-RAY DISCS

(75) Inventors: James Hindle, London (CA); Paul Rechsteiner, Toronto (CA)

(73) Assignee: KALEIDESCAPE, INC., Sunnyvale, CA (US)

(21) Appl. No.: 13/088,175

(22) Filed: Apr. 15, 2011

Related U.S. Application Data
(60) Provisional application No. 61/324,558, filed on Apr. 15, 2010.

(51) Int. Cl. G11B 7/085

(52) U.S. Cl. 369/30.08; G9B/7.042

(57) ABSTRACT

Described herein is a method of creating a bookmark to access digital content, including content on a Blu-ray disc. The method calls for extracting title and playlist information from a playback state corresponding to a specified location within the digital content; and creating a synthetic navigation stream to initiate playback of the digital content at the specified location.

### CROSS REFERENCE TO RELATED APPLICATIONS

This application claims priority to and the benefit under 35 U.S.C. §119(e) of copending U.S. Provisional Patent Application No. 61/324,558, entitled “BOOKMARKING DIGITAL CONTENT ON BLU-RAY DISCS” by Hindle et al., filed on Apr. 15, 2010, which is hereby incorporated by reference as if fully set forth herein.

### BACKGROUND:

1. Field

Embodiments relate to bookmarking digital content stored on Blu-ray formatted discs.

2. Related Art

Bookmarks for digital content add additional value to that content. Users enjoy the ability to directly access portions of the digital content such as a favorite scene, or to begin playback of a movie from the start of the movie itself, rather than beginning with a copyright notice or trailer. Moreover, bookmarks allow for additional functionality, such as adjusting masking elements or lighting in a theater room automatically at the start or end of a motion picture, or allowing a user to stop a movie and restart it at the same point at a later time.

Bookmarking for DVDs has a number of available solutions, including those detailed in U.S. Patent Publication 2004/0139047, by Rechsteiner et al., entitled “Bookmarks and Watchpoints for Selection and Presentation of Media Streams.” Providing bookmarks for other forms of digital content distribution, such as Blu-ray discs, requires solving problems not addressed in bookmarking earlier digital formats.

### SUMMARY

Described herein is a method of creating a bookmark to access digital content, including content on a Blu-ray disc. The method calls for extracting title and playlist information from a playback state corresponding to a specified location within the digital content; and creating a synthetic navigation stream to initiate playback of the digital content at the specified location.

Also detailed herein is a method of utilizing a bookmark to access digital content. This method calls for creating a synthetic navigation stream, with reference to the bookmark. Utilizing additional information associated with the bookmark, a specific location within the digital content is identified, and playback of the digital content is initiated at that specific location.

Another embodiment detailed herein describes a system for accessing digital content. The system includes a media server, for storing said digital content and a bookmark associated with the digital content, and a media player, communicatively coupled to the media server and to a display, for retrieving the digital content from the media server and outputting the digital content to the display. The media player is configured to initiate playback of the digital content by utilizing the bookmark to create a synthetic navigation stream, with reference to the bookmark. Then, utilizing additional information associated with the bookmark to identify a specific location within the digital content; the player can initiate playback of the digital content at that specific location.

### BRIEF DESCRIPTION OF THE DRAWINGS

The accompanying drawings, which are incorporated in and form a part of this specification, illustrate embodiments and, together with the description, serve to explain the principles of the pictured embodiments:

FIG. 1 depicts an exemplary computer system, upon which embodiments may be implemented.

FIG. 2 depicts an exemplary media server environment, in accordance with one embodiment.

FIG. 3 depicts an exemplary media server environment, in accordance with one embodiment.

FIG. 4 depicts an exemplary Blu-ray player, in accordance with one embodiment.

FIG. 5 depicts an exemplary Blu-ray disc, in accordance with one embodiment.

FIG. 6 depicts a bookmark, in accordance with one embodiment.

FIG. 7 depicts a method of creating a bookmark for digital content, in accordance with one embodiment.

FIG. 8 depicts a method of utilizing a bookmark for digital content, in accordance with one embodiment.

### DETAILED DESCRIPTION

Reference will now be made in detail to several embodiments. While the disclosure will be described in conjunction with the alternative embodiment(s), it will be understood that they are not intended to limit the disclosure to these embodiments. On the contrary, the disclosure is intended to cover alternative, modifications, and equivalents, which may be included within the spirit and scope of the disclosure as defined by the appended claims.

Furthermore, in the following detailed description, numerous specific details are set forth in order to provide a thorough understanding of the claimed subject matter. However, it will be recognized by one skilled in the art that embodiments may be practiced without these specific details or with equivalents thereof. In other instances, well-known methods, procedures, components, and circuits have not been described in detail as not to unnecessarily obscure aspects and features of the subject matter.

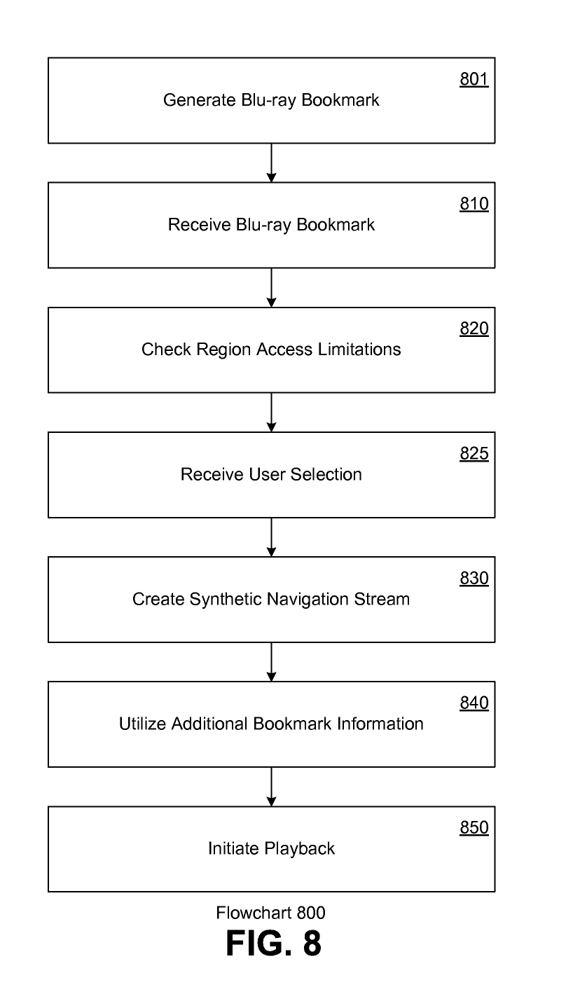

Portions of the detailed description that follows are presented and discussed in terms of a method. Although steps and sequencing thereof are disclosed in figures herein (e.g., FIG. 8) describing the operations of this method, such steps and sequencing are exemplary. Embodiments are well suited to performing various other steps or variations of the steps recited in the flowchart of the figure herein, and in a sequence other than that depicted and described herein.

Some portions of the detailed description are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout, discussions utilizing terms such as “accessing,” “writing,” “including,” “storing,” “transmitting,” “traversing,” “associating,” “identifying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Computing devices typically include at least some form of computer readable media. Computer readable media can be any available media that can be accessed by a computing device. By way of example, and not limitation, computer readable medium may comprise computer storage media and communication media. Computer storage media includes volatile and nonvolatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other medium which can be used to store the desired information and which can be accessed by a computing device. Communication media typically embodies computer readable instructions, data structures, program modules, or other data in a modulated data signals such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

Some embodiments may be described in the general context of computer-executable instructions, such as program modules, executed by one or more computers or other devices. Generally, program modules include routines, programs, objects, components, data structures, etc,. that perform particular tasks or implement particular abstract data types. Typically the functionality of the program modules may be combined or distributed as desired in various embodiments.

### BASIC COMPUTING SYSTEM

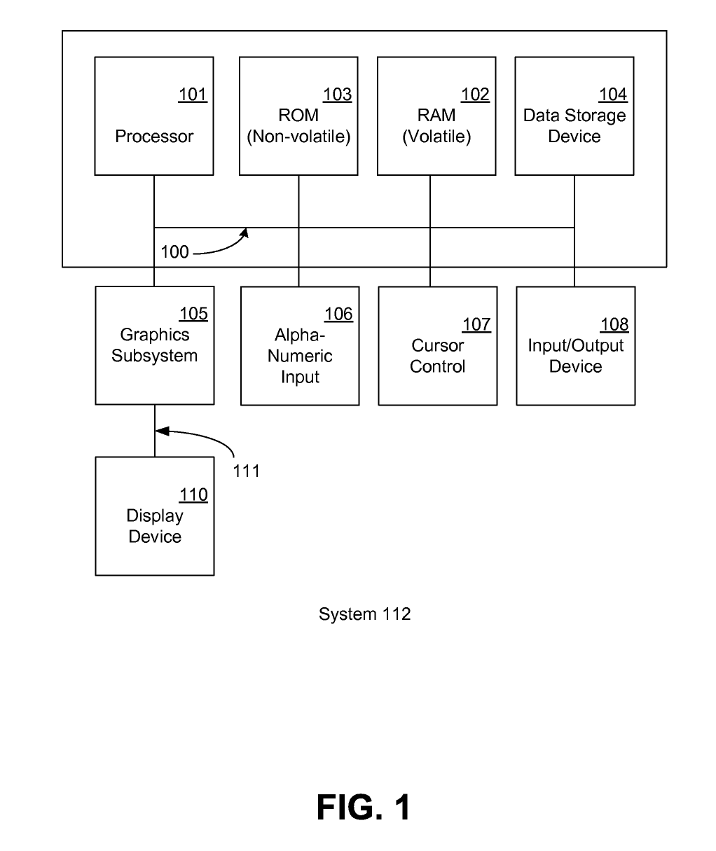

Referring now to FIG. 1, a block diagram of an exemplary computer system 112 is shown. It is appreciated that computer system 112 described herein illustrates an exemplary configuration of an operational platform upon which embodiments may be implemented to advantage. Nevertheless, other computer systems with differing configurations can also be used in place of computer system 112 within the scope of the present invention. For example, computer system 112 may include additional, fewer, or different elements other than those described in conjunction with FIG. 1. Moreover, embodiments may be practiced on any system which can be configured to enable it, not just computer systems like computer system 112. It is understood that embodiments can be practiced on many different types of computer system 112. System 112 can be implemented as, for example, a desktop computer system or server computer system having a powerful general-purpose CPU coupled to a dedicated graphics rendering GPU. In such an embodiment, components can be included that add peripheral buses, specialized audio/video components, IO devices, and the like. Similarly, system 112 can be implemented as a handheld device (e.g., cellphone, etc.) or a set-top video game console device such as, for example, the Xbox®, available from Microsoft Corporation of Redmond, Washington, or the PlayStation3 ®, available from Sony Computer Entertainment Corporation of Tokyo, Japan. System 112 can also be implemented as a “system on a chip”, where the electronics (e.g., the components 101, 103, 105, 106, and the like) of a computing device are wholly contained within a single integrated circuit die. Examples include a hand-held instrument with a display, a car navigation system, a portable entertainment system, and the like.

Computer system 112 comprises an address/data bus 100 for communicating information, a central processor 101 coupled with bus 100 for processing information and instructions; a volatile memory unit 102 (e.g., random access memory [RAM], static RAM, dynamic RAM, etc.) coupled with bus 100 for storing information and instructions for central processor 101; and a non-volatile memory unit 103 (e.g., read only memory [ROM], programmable ROM, flash memory, etc.) coupled with bus 100 for storing static information and instructions for processor 101. Moreover, computer system 112 also comprises a data storage device 104 (e.g., hard disk drive) for storing information and instructions.

Computer system 112 also comprises an optional graphics subsystem 105, an optional alphanumeric input device 106, an optional cursor control or directing device 107, and signal communication interface (input/output device) 108. Optional alphanumeric input device 106 can communicate information and command selections to central processor 101. Optional cursor control or directing device 107 is coupled to bus 100 for communicating user input information and command selections to central processor 101. Signal communication interface (input/output device) 108, which is also coupled to bus 100, can be a serial port. Communication interface 108 may also include wireless communication mechanisms. Using communication interface 108, computer system 112 can be communicatively coupled to other computer systems over a communication network such as the Internet or an intranet (e.g., a local area network), or can receive data (e.g., a digital television signal). Computer system 112 may also comprise graphics subsystem 105 for presenting information to the computer user, e.g., by displaying information on an attached display device 110, connected by a video cable 111. In some embodiments, graphics subsystem 105 is incorporated into central processor 101. In other embodiments, graphics subsystem 105 is a separate, discrete component. In other embodiments, graphics subsystem 105 is incorporated into another component. In other embodiments, graphics subsystem 105 is included in system 112 in other ways.

### EXEMPLARY MEDIA SERVER ENVIRONMENT

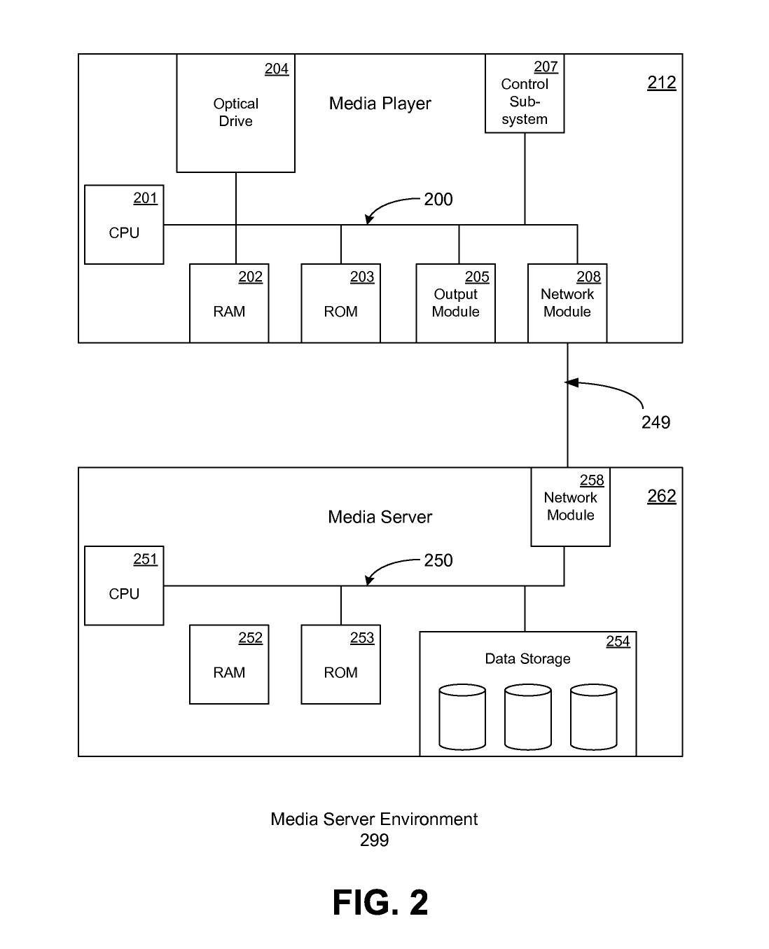

With reference now to FIG. 2, an exemplary media server environment 299 is depicted, in accordance with one embodiment. While media server environment 299 is shown as incorporating specific, enumerated features and elements, it is understood that embodiments are well suited to applications having additional, fewer, or different arrangements of features or elements. For example, the functionality described herein may be incorporated into a single physical device, or spread across additional devices.

Media server environment 299 is shown as comprising two devices: media player 212, and media server 262. Media player 212 includes: bus 200 for communicating information; a central processor 201 coupled with bus 200 for processing information and instructions; a volatile memory unit 202 (e.g., random access memory [RAM], static RAM, dynamic RAM, etc.) coupled with bus 200 for storing information and instructions for central processor 201; and a non-volatile memory unit 203 (e.g., read only memory [ROM], programmable ROM, flash memory, etc.) coupled with bus 200 for storing static information and instructions for processor 201. Moreover, media player 212 incorporates optical drive 204, coupled with bus 200, for accessing data stored on optical media, e.g., CDs, DVDs, or Blu-ray discs (BDs). Media player 212 also incorporates output module 205, coupled with bus 200, for outputting audio and/or video data. Media player 212 is also shown as incorporating networking module 208, coupled with bus 200, for transmitting and receiving information, e.g., over a network connection. In the depicted embodiment, media player 212 also incorporates control subsystem 207. Control subsystem 207 is coupled with bus 200, and receives control signals for controlling the functionality of media player 212, as well as for manipulating digital content being played on media player 212.

As shown in the depicted embodiment, media player 212 is communicatively coupled to media server 262 via network connection 249. In different embodiments, network connection 249 may be implemented in different ways. For example, network connection 249 may be implemented as a TCP/IP connection, transmitted via Ethernet or a wireless connection.

Media server 262 includes: bus 250 for communicating information; a CPU 251 coupled with bus 250 for processing information and instructions; a volatile memory unit 252 (e.g., random access memory [RAM], static RAM, dynamic RAM, etc.) coupled with bus 250 for storing information and instructions for central processor 251; and a non-volatile memory unit 253 (e.g., read only memory [ROM], programmable ROM, flash memory, etc.) coupled with bus 250 for storing static information and instructions for processor 251. Media server 262 also includes data storage device 254, depicted here as a RAID array (redundant array of inexpensive disks), coupled with bus 250 for storing digital media content. Media server 262 further includes networking module 258, coupled with bus 250, for transmitting and receiving information, e.g., over a network connection.

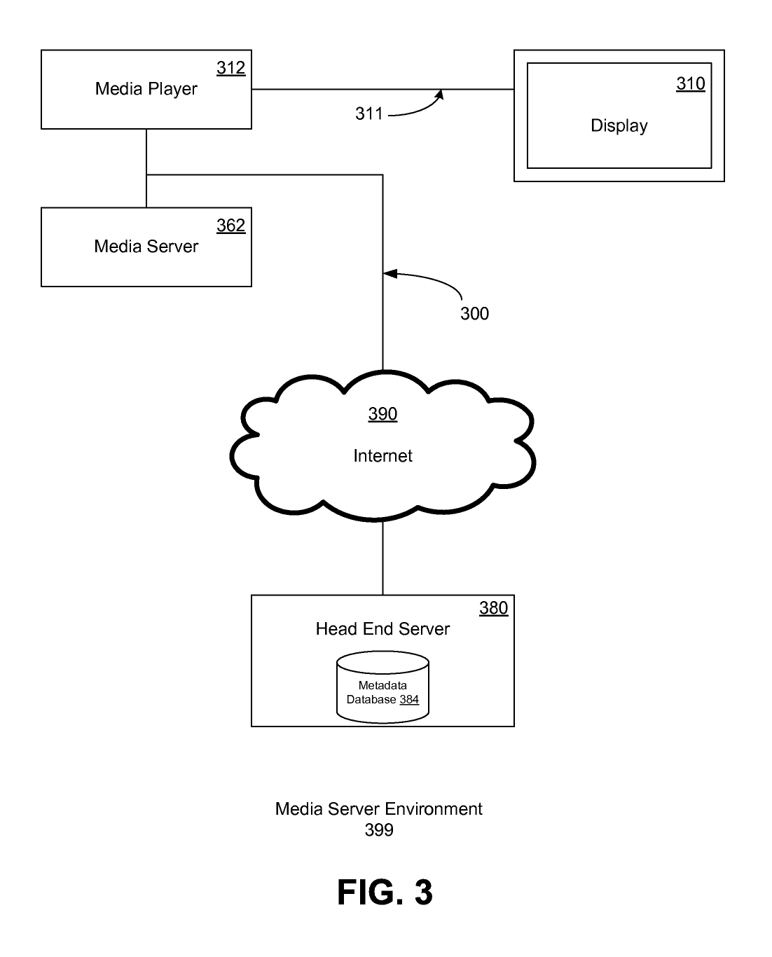

With reference now to FIG. 3, an exemplary media server environment 399 is depicted, in accordance with one embodiment. While media server environment 399 is shown as incorporating specific, enumerated features and elements, it is understood that embodiments are well suited to applications having additional, fewer, or different arrangements of features or elements. For example, the functionality described herein may be incorporated into a single physical device, or spread across additional devices.

In the depicted embodiment, media server 362 is used to store digital media content. Media server 362 is communicatively coupled with media player 312 via network connection 300. Media player 312, in the depicted embodiment, retrieves digital media content from server 362 and plays it back, e.g., by outputting digital video content over video cable 311 to display 310. Media server 362 is also communicatively coupled to a head end database 380, via network connection 300, and the Internet 390. Head end database 380 includes metadata database 384. Media server 362, in this embodiment, is configured to retrieve metadata corresponding to digital content from metadata database 384.

In different embodiments, digital media content may be available from sources other than media server 362. In one such embodiment, for example, media server 362 and/or media player 312 may be able to access or download digital media content from a remote source, e.g., head end database 380, or a remote digital media storage device (not pictured). Similarly, in some embodiments, digital media content may be available in accordance with a digital rights management (DRM) scheme, such as a “rental” scenario where digital media content is available to be viewed for a fixed length of time, or for a specified number of playbacks.

### CREATING BLU-RAY BOOKMARKS

Bookmarking Blu-ray media offers some additional challenges, in comparison with bookmarking standard DVDs. Not only does the Blu-ray format include additional options which should be accounted for in the bookmarking process, it also includes several completely different authoring modes for titles on Blu-ray discs within the unified specification: HDMV and BD-J. HDMV titles are similar to DVDs in a number of ways, and tools for bookmarking discs authored in HDMV movie mode are commercially available. BD-J titles, however, are more problematic.

BD-J titles operate by loading Java programs, or “xlets,” onto the Blu-ray player. This Java program controls access to the data contained on the disc. In order to provide bookmarks for BD-J titles, it is important to be able to determine which content is being accessed at a given moment, and where that content is stored on the disc.

One approach to providing a BD-J bookmarking solution is to bypass the Java programs ordinarily used to access the digital content stored on the disc entirely. Instead, a synthetic navigation program can be constructed. This synthetic navigation program essentially mimics an HDMV title, and uses the HDMV playback mode of the Blu-ray player in order to access the digital content associated with the BD-J title directly. This approach is explored in greater detail herein. Similarly, embodiments are well suited to other uses, where a navigation layer can be generated to allow access to content from outside the normal control software.

### EXEMPLARY BLU-RAY PLAYER

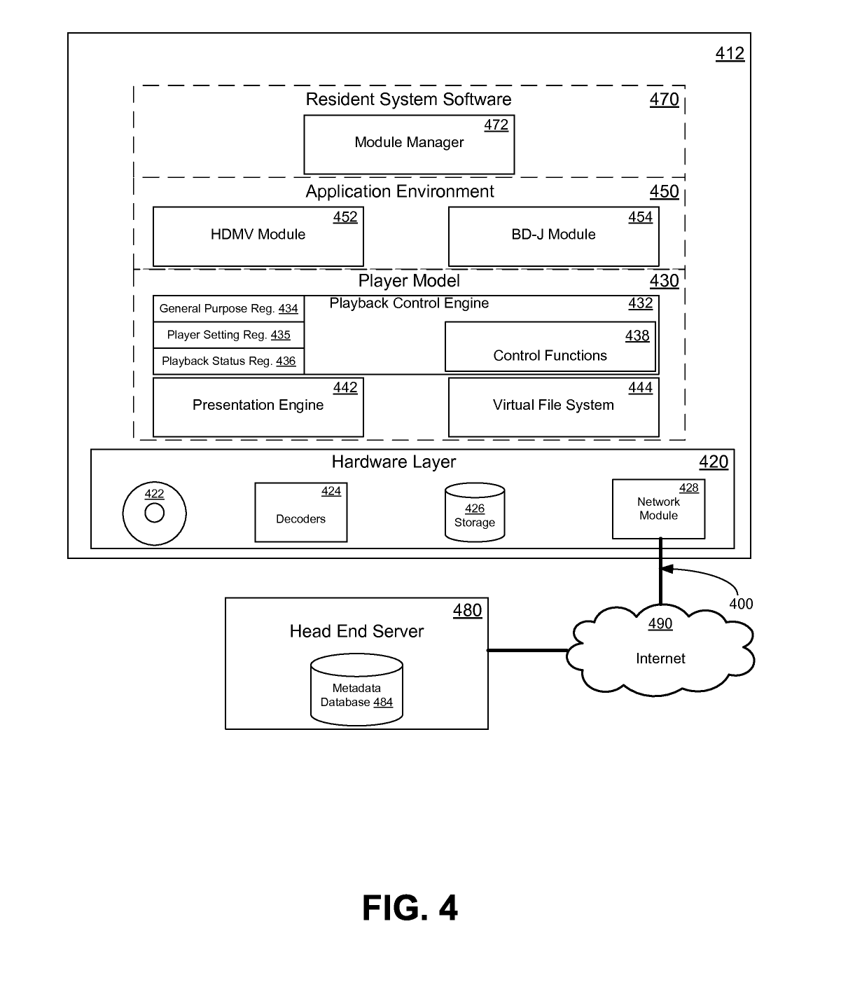

With reference now to FIG. 4, an exemplary Blu-ray player 412 is depicted, in accordance with one embodiment. While Blu-ray player 412 is shown as including specific, enumerated features and elements, it is understood that embodiments are well-suited to devices having additional, fewer, or different features and elements. It is understood that Blu-ray player 412 is well-suited for use in combination with various embodiments, such as exemplary media server environment 399.

Blu-ray player 412 is depicted as being divided into a number of implementation layers, arranged in a somewhat hierarchical manner. Each implementation layer may have one or more systems included therein. Hardware layer 420, for example, is depicted as including some of the hardware elements of Blu-ray player 412: these include disc 422, on which digital content may be stored; decoders 424, which may be used to decode digital content accessed from disc 422; storage 426, which may be used to store information; and network module 428, which may be used to communicate with head end server 480 and/or access metadata database 484, via networking connection 400 and Internet 490.

Blu-ray player 412 is also shown as including player model 430. Player model 430 includes playback control engine 432, presentation engine 442, and virtual filesystem 444. Playback control engine 432 includes control functions 438, and three sets of registers: general-purpose registers 434, player setting registers 435, and playback status registers 436.

Blu-ray player 412 is also depicted as including application environment 450.

Application environment 450 includes HDMV module 452, and BD-J module 454.

Blu-ray player 412 is depicted as including resident system software 470, which includes module manager 472.

### EXEMPLARY BLU-RAY DISC

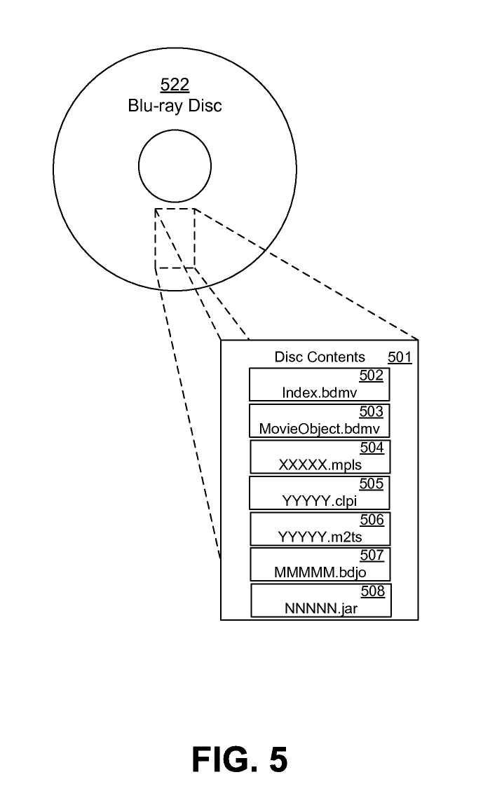

With reference now to FIG. 5, an exemplary Blu-ray disc 522 is depicted, in accordance with one embodiment. While disc 522 is shown as incorporating specific, enumerated features and elements, it is understood that embodiments are well-suited to applications involving additional, fewer, or different features and elements.

Disc 522 is shown as including disc contents 501. In the depicted embodiment, disc contents 501 includes the following: index.bdmv 502, MovieObject.bdmv 503, one or more XXXXX.mpls 504, one or more YYYYY.clpi 505, one or more YYYYY.m2ts 506, one or more MMMMM.bdjo 507, and one or more NNNNN.jar 508. Index.bdmv 502 describes the contents of disc 522, e.g., the “titles” available for playback on disc 522, in the manner expected by a Blu-ray player, such as Blu-ray player 412. MovieObject.bdmv 503 contains the navigation programs for the various HDMV titles included on disc 522 (and references to the bdjo files for BD-J titles). Files such as XXXXX.mpls 504 store information relating to movie playlists contained on disc 522; on many Blu-ray discs, “XXXXX” corresponds to a five digit number identifying a particular playlist, and there will be a separate XXXXX.mpls 504 file for each playlist available on disc 522. Files such as YYYYY.clpi 505 store clip information associated with a Blu-ray clip AV stream; on many Blu-ray discs, “YYYYY” corresponds to a five digit number identifying a particular clip, and there will be a separate YYYYY.clpi 505 file for each clip available on disc 522. Files such as YYYYY.m2ts 506 contain encoded AV data corresponding a particular clip; on many Blu-ray discs, “YYYYY” corresponds to a five digit number identifying a particular AV stream, and there will be a separate YYYYY.m2ts 506 file for each AV stream available on disc 522, where the same five digit number YYYYY is used for an AV stream file and its corresponding clip. Files such as MMMMM.bdjo 507 are BD-J object files; a BD-J title included on disc 522 is included in MovieObject.bdmv file 503, and references a corresponding MMMMM.bdjo 507 file. Files such as NNNNN.jar 508 are Java archive files; a BD-J object file, such as MMMMM.bdjo 507, may reference a jar file like NNNNN.jar 508; such Java archive files may contain a Java xlet, which may control access to digital content stored on disc 522.

### STRUCTURE OF A BLU-RAY BOOKMARK

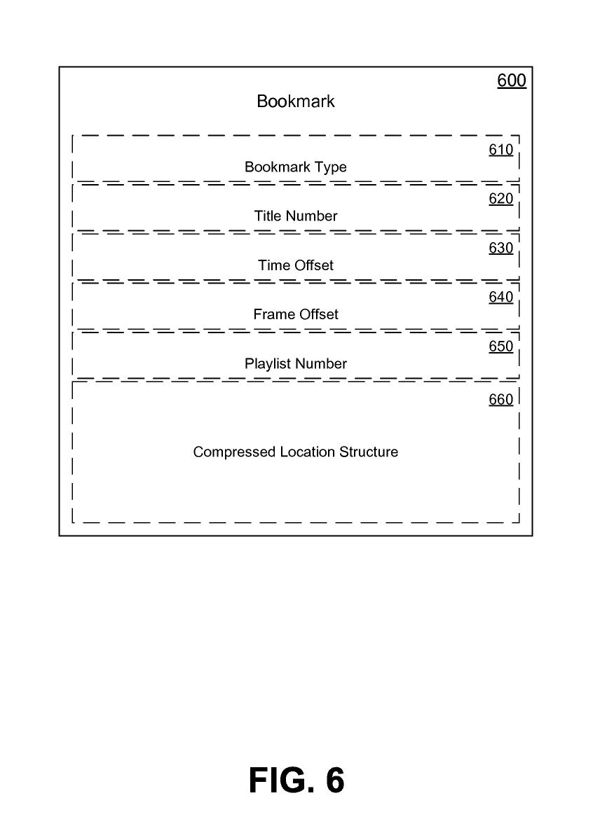

With reference now to FIG. 6, bookmark 600 is depicted, in accordance with one embodiment. While bookmark 600 is shown as incorporating specific, enumerated features and elements, it is understood that embodiments are well-suited to applications involving additional, fewer, or different features or elements.

Bookmark 600 is shown as including a bookmark type 610. Bookmark type 610 is utilized in some embodiments, to distinguish between various types of bookmarks, e.g., DVD, HDMV, and BD-J bookmarks.

Bookmark 600 includes title number 620. In some embodiments, title number 620 is used to indicate which title number on a Blu-ray disc is to be accessed. Moreover, in some embodiments, title numbers are used for access-control or digital rights management (DRM) schemes; access restrictions and key information may be title number dependent.

Bookmark 600 includes time offset 630. In some embodiments, time offset 630 is used to indicate at which point within a particular title, the digital content should be accessed, e.g., 6:37 from the beginning of the specified title.

Bookmark 600 includes frame offset 640. In some embodiments, frame offset 640 is used to further indicate at which point within a particular title, the digital content should be accessed. In some embodiments, where a time offset such as time offset 630 only provides for accuracy to a second, frame offset 640 provides additional granularity for choosing a location for a bookmark.

Bookmark 600 also includes playlist number 650. In some embodiments, such as for BD-J titles, it is helpful to extract the playlist number corresponding to the location to be bookmarked.

Bookmark 600 is also depicted as including a compressed location structure 660. In some embodiments, compressed location structure 660 is a heavily-compressed binary structure, corresponding to a binary structure which describes a bookmark location for an HDMV-authored Blu-ray disc. In some embodiments, this binary structure may be generated by a commercially-available bookmarking solution for HDMV-authored discs. In several such embodiments, the binary structure describes the status of some or all of the registers of a Blu-ray player, such as registers 434, 435, and 436 of Blu-ray player 412, at the time corresponding to the bookmark. These registers may contain information relating to the playback of digital content at a given time or location, such as: branching information; camera angle information; audio track selection; subtitle status; region information; or allowable user control information. In many instances, this binary structure can be significantly compressed.

In some embodiments, bookmark 600 is a combination of string variables and the compressed binary location structure. In other embodiments, bookmark 600 may be implemented in different ways.

In some embodiments, bookmarks may be used for comparison against other bookmarks, or against the current state of playback of digital content. In one such embodiment, such bookmark comparison may ignore the binary location structure during comparison, or the binary location structure may be omitted. Bookmark comparison allows for location determinations such as deciding whether the current playback position is before, equal to, or after (or not comparable to) a specified bookmark location. This, in turn, allows for the implementation of features such as watchpoints, favorite scenes, lighting and/or masking cues at the beginning or end of a piece of digital content, determination of when the end credits have begun, identification of a particular episode of episodic content, or other features.

### CREATING AND UTILIZING A SYNTHETIC NAVIGATION PROGRAM

In order to generate a synthetic navigation program, certain information is collected from a BD-J title. In some embodiments, playback of a BD-J title is initiated, and for a selected point of interest, e.g., a point to be bookmarked, the state of the playback engine for the Blu-ray player can be examined. From the playback control engine, the current title and playlist numbers corresponding to the selected point of interest can be extracted, e.g., title n and playlist x.

Next, in order to generate a synthetic navigation program, two synthetic files are generated in the volatile memory of the Blu-ray player 412. A synthetic index.bdmv file for the disc is created, listing all of the titles available on the disc up to the title corresponding to the selected point of interest. For example, if the point of interest occurs in title n, the synthetic index.bdmv file defines titles 0 through n. Similarly, a synthetic MovieObject.bdmv file for the disc is created. As with the synthetic index.bdmv file, the synthetic MovieObject.bdmv file includes an entry for every title on the disc up to the title corresponding to the selected point of interest, e.g., titles 0-n. For every title that does not correspond to the selected point of interest, the corresponding navigation program within the synthetic MovieObject.bdmv file instructs the Blu-ray player to jump to the title corresponding to the selected point of interest, e.g., title n. For the title corresponding to the selected point of interest, e.g., title n, the corresponding navigation program instructs the Blu-ray player to playback the playlist corresponding to the point of interest, e.g., playlist x.

These two synthetic files can be placed in the memory of a Blu-ray player, and remapped such that when the Blu-ray player attempts to access the normal playback instructions for a BD-J title, the synthetic files are accessed instead. In accordance with the defined behavior of a Blu-ray player, upon accessing these files the module manager is instructed to select the HDMV module instead of the BD-J module. The AV streams included on a Blu-ray disc are not specific to the type of authoring used to create the disc; an HDMV and a BD-J version of the exact same movie would have identical AV streams included on the discs, even though the authoring used to generate each title differs. As such, a synthetic HDMV navigation stream can be used to access to the AV streams stored on a disc, even if the content is usually accessed via a title authored using BD-J.

Once the two synthetic files are generated, playback can be restarted using these synthetic files, instead of the original BD-J instructions. The digital content corresponding to the selected playlist will be presented via the HDMV module. When the selected point of interest occurs, additional bookmark information, including a location structure, can be extracted using available tools for capturing bookmarks during HDMV playback. In some embodiments, the location structure may be compressed in order to reduce the overall size of the bookmark.

Accessing digital content using a bookmark created by this method is similar. A bookmark may be generated by one Blu-ray player, and distributed to one or more other players, e.g., via a network connection to some head end server, or placing the bookmark in storage accessible to the Blu-ray player. When the disc is accessed, the bookmarked locations can be presented as options for viewing, e.g., “Play Main Feature.” If one of these bookmarked locations is selected, a synthetic navigation stream is generated by using the title and playlist information included in the bookmark. Once the synthetic navigation stream has been created, the time offset and frame offset information also included in the bookmark is used to access the AV stream at the appropriate location. The compressed structure information is used to set the registers in the Blu-ray player to the appropriate states, and playback begins from the location corresponding to the bookmark.

Alternatively, in some embodiments, an appropriate synthetic navigation program may be distributed in conjunction with the bookmark, or instead of the bookmark.

### ADDITIONAL BOOKMARK CONSIDERATIONS

Several additional considerations apply to bookmarking digital content on Blu-ray discs, in certain embodiments. Many of these considerations may apply to both HDMV and BD-J authored titles. Others may be specific to one or the other method of authoring.

In different embodiments, which registers are set during bookmark utilization may vary. For example, the general purpose and playback status registers may be changed to the values specified by the location structure included in the bookmark, while the player status registers, which include settings such as player region, player language preferences, and player profiles, are not altered. In several such embodiments, the location structure included in the bookmark will not include player status register settings.

Moreover, playback status register information for a Blu-ray player utilizing a bookmark may be used to override register settings specified in that bookmark in some embodiments. These playback status registers will be changed to match the bookmark, and then a subset of registers will be reset to reflect local player or user preferences. For example, a bookmark may specify playback status register settings affecting the language or subtitles used for the presentation of the bookmarked digital content. After these playback status register settings are restored, the Blu-ray player may apply the user's specified preferences to supersede the playback status register settings, e.g., by changing the playback status register settings to match the user-defined default settings for that Blu-ray player. In one such embodiment, externally-procured bookmarks, such as those obtained from a head-end server, are handled in this manner, while locally-generated bookmarks, including “favorite scene” and “pause” bookmarks, will use the settings that were active when the bookmark was created. In other embodiments, bookmarks may include fewer playback status register settings, e.g., intentionally avoiding those playback status registers that are likely to contain user preferences; alternatively, the Blu-ray player utilizing a bookmark may ignore certain playback status register changes indicated by the bookmark. In some embodiments, an algorithm may be applied to determine the most useful or appropriate setting for the playback status registers.

Blu-ray discs may include a “mask” of allowable user actions, sometimes referred to as “trick play” commands; this mask may differ for different content included on the disc, or for different portions of the same content. The mask is interpreted by the Blu-ray player, in order to react to user commands. For example, “fast forward” and “chapter skip” may be allowed during playback of the main feature, but disabled during the showing of a copyright notice or a preview; a different mask is applied during navigation of a disc menu than during playback of content. For BD-J authored content, the content author has additional control, in that the Java xlet can intercept trick play commands, and instruct the Blu-ray player to perform certain actions as a result. In some cases, the mask for BD-J authored content may instruct the Blu-ray player to completely ignore trick play commands, while the xlet selects an appropriate response.

For bookmarked BD-J content, in some embodiments it is advantageous to override the original mask associated with the Blu-ray disc, and provide an alternative mask. In this manner, a user viewing a synthetic navigation stream via a bookmark will be able to use the trick play commands, and the Blu-ray player will operate in an expected manner. This embodiment addresses the problem where the original Blu-ray disc mask disabled trick play commands, in favor of the BD-J xlet, but without the xlet running, the player would not respond to any user trick play commands.

Blu-ray discs, or some content stored on them, may be associated with specific regions. For example, a particular Blu-ray disc may have different content accessible to region A players, than is accessible to region B or C players. For BD-J titles, region controls are often built into the Java program; in situations where the Java program is not utilized to access digital content, such as where a synthetic navigation stream is used, these region restrictions would not be enforced. In some embodiments, in order to honor the region access limitations, additional steps may be implemented. For example, if a bookmark is generated on a region A player, and a region B player attempts to access that bookmark and the associated Blu-ray disc, the player should compare the player's region with the region limitations of the content, which may be included in the bookmark, or may be accessible from another source, e.g., metadata provided from a head-end server or other remote source regarding; if the player is not authorized to access the content indicated by the bookmark, the bookmark should not be utilized.

In some embodiments, it is sufficient to have a region-appropriate player within the same environment. For example, if Media Server Environment 399 included a Region A media player and a Region B media player, then both media players may be allowed to utilize bookmarks for both Region A and Region B content; neither player may be allowed to utilize bookmarks for Region C content in this case. In further embodiments, region restrictions may not be enforced, e.g., in cases where the appropriate region for the content may not be known.

In some embodiments, it is advantageous to be able to determine the time between two bookmarks, or between a bookmark and a watchpoint, e.g., in order to provide “Run length” information for a piece of digital content defined by a start bookmark and an end bookmark or watchpoint. For content that is completely contained within a single title (for Blu-ray discs) or a single program chain (for DVDs), the time offset and frame offset from the start and end bookmarks can be arithmetically compared, to determine a total run length. For start/end points that lie in different titles or program chains, it is necessary first to determine whether any additional titles or program chains are included in playback, e.g., playback may begin from a bookmark in Title A, continue through all of Title B, and conclude in Title C. Once this determination has been made, mathematical means can be used to determine a total run length.

In some embodiments, it may be useful to use certain information related to a bookmark from a synthetic HDMV stream, in concert with playback of the original BD-J content. For example, a Blu-ray player may have certain functionality that should trigger upon completion of playback of content, such as player status should return to a top-level menu or interface. In one embodiment, it is possible to examine the time offset and frame offset information contained in a bookmark, and compare it with the current playback position of a BD-J title. Because the content being accessed is the same, even though the bookmark is intended for use in combination with a synthetic HDMV title, the times involved may be directly compared, and used to trigger behavior, e.g., in combination with watchpoint functionality.

While many of the embodiments described herein are presented in terms of accessing content stored on a disc, e.g., disc 422, it is understood that embodiments are well-suited to other implementations as well. For example, in one embodiment, content may be copied from a disc to another storage medium, and accessed from there. Such an embodiment would apply to a media player/server environment, such as that depicted in FIG. 2: the content from a Blu-ray disc could be read by media player 212, via optical drive 204, and stored remotely in data storage 254, on media server 262. Bookmarks could then be used to access selected portions of the digital content stored on the media server, rather than reading from the disc itself. Similarly, a Blu-ray player may have internal storage available, upon which digital content may be stored, and bookmarks used to access the content.

### METHOD OF CREATING A BOOKMARK FOR BD-J CONTENT

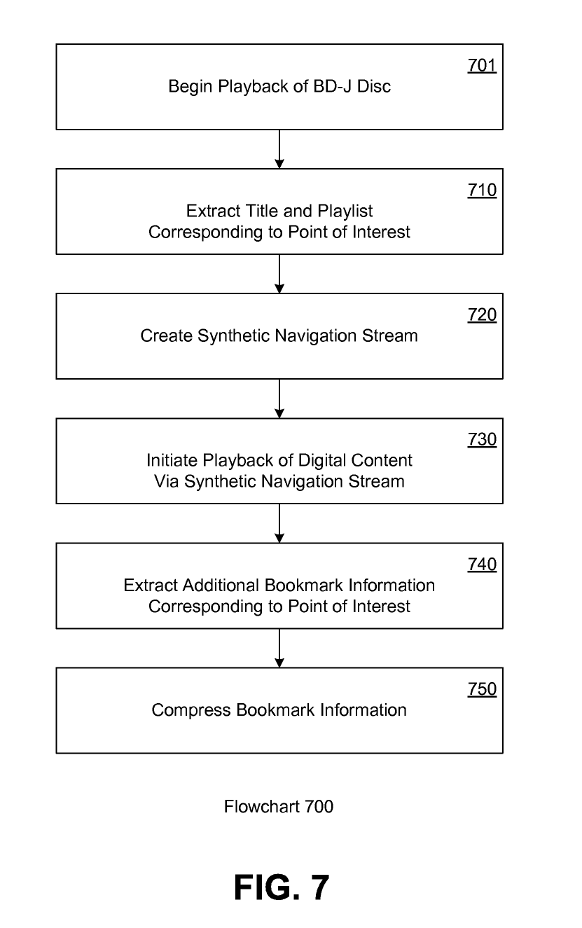

With reference now to FIG. 7, a flowchart 700 of a method of creating a bookmark for digital content stored on a BD-J authored Blu-ray disc is depicted, in accordance with one embodiment. Although specific steps are disclosed in flowchart 700, such steps are exemplary. That is, embodiments are well suited to performing various other (additional) steps or variations of the steps recited in flowchart 700. It is appreciated that the steps in flowchart 700 may be performed in an order different than presented, and that not all of the steps in flowchart 700 may be performed.

With reference now to step 701, playback is initiated for digital content stored on a BD-J authored title on a Blu-ray disc. In some embodiments, playback may be initiated on a specialized version of a Blu-ray player, which is configured to allow a user to indicate a point of interest during playback of digital content, and which is further configured to capture information from the playback control engine when a point of interest is so indicated.

For example, with reference to FIG. 4, Blu-ray player 412 begins playback of disc 422.

With reference now to step 710, playback state information, such as title and playlist information, corresponding to a point of interest or other specified location is extracted or otherwise obtained. In some embodiments, a user may indicate a point of interest during playback of digital content, e.g., by hitting a particular key or button. When a point of interest is so indicated, the current title and playlist information corresponding to that point of interest is extracted from the playback control engine, e.g., by capturing information from the playback status registers. In some embodiments, this process may be repeated, such that a user may indicate multiple such points of interest while allowing the playback of the digital content to continue.

For example, with reference to FIG. 4, when a point of interest is indicated, title and playlist information is extracted from playback status registers 436, e.g., title n and playlist x.

With reference now to step 720, a synthetic navigation stream is created. In some embodiments, the title and playlist information previously extracted can be used to generate several synthetic files in the memory of the Blu-ray player. In one such embodiment, a synthetic index.bdmv file is created, with entries for every title on the disc up to and including the title corresponding to the point of interest. Similarly, a synthetic MovieObject.bdmv file is created, with entries for every title on the disc up to and including the title corresponding to the point of interest, wherein the navigation program for every title not corresponding to the point of interest instructs the Blu-ray player to play the title corresponding to the point of interest, and wherein the navigation program for the title corresponding to the point of interest instructs the Blu-ray player to begin playback of the playlist corresponding to the point of interest.

Continuing the example, a synthetic index.bdmv file is created in the memory of Blu-ray player 412, having entries for titles from 0 to n. Similarly, a synthetic MovieObject.bdmv file is created in the memory of Blu-ray player 412, also having entries for titles from 0 to n. For title 0 through n-1, the navigation program provided in the synthetic MovieObject.bdmv file instructs Blu-ray player 412 to jump to title n. For title n, a navigation program provided in the synthetic MovieObject.bdmv file instructs Blu-ray player 412 to begin playback at playlist x.

With reference now to step 730, playback of the digital content on the disc is initiated via the synthetic navigation stream. In some embodiments, the Blu-ray player can be instructed to select the HDMV module, instead of the BD-J module, and to use the synthetic navigation stream created in the Blu-ray player's memory to initiate playback. Playback will begin from the title and playlist corresponding to the point of interest.

Continuing the preceding example, module manager 472 selects HDMV module 452 for playback of the digital content stored on disc 422. Playback control engine 432 accesses the synthetic files generated in the memory of Blu-ray player 412, and initiates playback at title n, playlist x.

With reference now to step 740, additional bookmark information is extracted corresponding to the point of interest. In some embodiments, during playback of the digital content via the synthetic navigation stream, additional bookmark information corresponding to the point of interest can be collected. For example, a time offset and a frame offset can be obtained from the playback control engine. Similarly, in some embodiments, tools can be used to extract a location structure corresponding to the point of interest from the playback control engine, where the location structure contains information about the states of the registers.

Continuing the preceding example, when the point of interest is reached during playback of the digital content stored on disc 422, the current time offset and frame offset is obtained from playback control engine 432, and a location structure is extracted, indicating the state of playback status registers 436.

With reference now to step 750, in some embodiments, the bookmark information is compressed. In several such embodiments, the location structure, in uncompressed form, may represent several thousand bytes. Frequently, this information can be easily compressed down to several hundred bytes or less using well-known compression techniques, as the states of many of the general purpose and playback status registers will often be zero.

### METHOD OF UTILIZING A BLU-RAY BOOKMARK

With reference now to FIG. 8, a flowchart 800 of a method of utilizing a bookmark for digital content stored on a BD-J authored Blu-ray disc is depicted, in accordance with one embodiment. Although specific steps are disclosed in flowchart 800, such steps are exemplary. That is, embodiments are well suited to performing various other (additional) steps or variations of the steps recited in flowchart 800. It is appreciated that the steps in flowchart 800 may be performed in an order different than presented, and that not all of the steps in flowchart 800 may be performed.

With reference to step 801, a bookmark is generated for a BD-J authored Blu-ray disc. In different embodiments, this bookmark may be generated in different ways. For example, the method described above with reference to FIG. 7 may be utilized. Additionally, a bookmark may be created by the action of a user accessing digital content, e.g., by pausing or stopping playback of the digital content, or by selecting start and end points of a favorite scene, or by the actions of another device, e.g., the phone rings, the doorbell rings, or some other device instructs a media player to generate a bookmark. It is understood that a single title or Blu-ray disc may have multiple bookmarks associated therewith, e.g., when the Blu-ray disc contains multiple pieces of episodic content, or different versions of a feature, or a favorite scene or pause bookmark has been created for the disc.

With reference now to step 810, the bookmark is received by a Blu-ray player (or other playback device). In different embodiments, distribution of a bookmark may be handled in different ways. As previously discussed, for example, bookmarks may be distributed from a head end or remote server to the Blu-ray player; alternatively, bookmarks may be available in a storage device accessible by the Blu-ray player, or bookmarks may be included on optical or digital storage, including the Blu-ray disc associated with the bookmark.

For example, with reference to FIGS. 4 and 6, media player 412 receives bookmark 600, corresponding to disc 422, from the head end server 480, via network connection 400.

With reference now to step 820, region settings for the Blu-ray player are compared with region access controls for digital content associated with the bookmark. As discussed above, in some embodiments, the region settings for the Blu-ray player are compared against the region access limitations for the digital content that is associated with the bookmark. In such embodiments, if the region settings for the content would not allow the Blu-ray player to access that content, utilization of the bookmark should not allow access to that content. Accordingly, the Blu-ray player should not utilize the bookmark to access the content. In some embodiments, bookmarks may be utilized specifically to access content which might otherwise be inaccessible. Also as discussed above, other embodiments may allow access to content if another Blu-ray player with an appropriate region setting is in the same environment. In other embodiments, this step may be omitted.

Continuing the preceding example, media player 412 consults a region setting in player setting registers 435, and obtains region information corresponding to the digital content stored on disc 422 from metadata database 484, located in head end server 480. If the combination of the region setting and the region information would allow media player 412 to access disc 422, then accessing the digital content via the bookmark is permitted.

With reference now to step 825, the bookmark is selected. In some embodiments, the playback device receives a user instruction, indicating, by selection of the bookmark, that a user wishes to initiate playback of the digital content stored on the BD-J authored Blu-ray disc. In other embodiments, other approaches may be used to access a bookmark. For example, in one embodiment, a user instruction to “Play Movie” may invoke a bookmark selection algorithm, where an appropriate bookmark is selected from a plurality of available bookmarks, e.g., if a “Pause” bookmark is associated with the movie, it should be selected in preference to a “Start of feature” bookmark.

With reference now to step 830, the bookmark is used to generate a synthetic navigation stream. As discussed above, in some embodiments the synthetic navigation stream consists of a index.bdmv file and a MovieObject.bdmv file. These files are placed in the memory of the Blu-ray player.

Continuing the preceding example, media player 412 generates a index.bdmv file and a MovieObject.bdmv file from title number 620 and playlist number 650 in bookmark 600, and stores these files in the memory of Blu-ray player 412.

With reference now to step 840, additional information contained within the bookmark is utilized. As discussed above, in different embodiments, different information may be included in the bookmark. For example, a bookmark may include a time offset and a frame offset to identify a specific location within a specified title and playlist on the disc. Additionally, the bookmark may include register information, such as settings indicating the appropriate state for general purpose and/or playback status registers. As noted above, certain user preferences and/or player setting registers may influence whether or not register settings included in the register information are applied.

Continuing the preceding example, media player 412 extracts time offset 630 and frame offset 640 from bookmark 600, in order to identify a specific frame in which to begin playback of digital content stored on disc 422. Additionally, media player 412 extracts compressed location structure 660 from bookmark 600, decompresses it, and applies general-purpose and playback status register information included in the location structure.

With reference now to step 850, playback of the digital content is initiated at the location specified by the bookmark. In some embodiments, as previously discussed, the module manager of the Blu-ray player initiates playback. The synthetic navigation stream loaded into the Blu-ray player's memory causes the player to initiate playback using the HDMV module, rather than BD-J module, and to begin playback at the location specified by the bookmark.

Continuing the preceding example, module manager 472 initiates playback of digital content identified by bookmark 600. The synthetic navigation stream loaded into the memory of Blu-ray player 412 causes HDMV module 452 to be utilized, rather than BD-J module 454.

Embodiments of the present disclosure are thus described. While the present disclosure has been described in particular embodiments, it should be appreciated that the present disclosure should not be construed as limited by such embodiments, but rather construed according to the following claims.

What is claimed is:

1. A method of creating a bookmark to access digital content, comprising:
extracting title and playlist information from a playback state corresponding to a specified location within said digital content; and
creating a synthetic navigation stream to initiate playback of said digital content at said specified location.

2. The method of claim 1, wherein said synthetic navigation stream comprises:
a first synthetic file, comprising a listing of a plurality of titles associated with said digital content; and
a second synthetic file, comprising a plurality of navigation programs associated with said plurality of titles.

3. The method of claim 1, further comprising:
initiating playback of said digital content with reference to said synthetic navigation stream;
extracting additional bookmark information from a second playback state; and
creating said bookmark, with reference to said synthetic navigation stream and said additional bookmark information.

4. The method of claim 3, further comprising:
compressing said bookmark.

5. The method of claim 3, wherein said additional bookmark information comprises one or more of: a time offset; a frame offset; and a location structure.

6. The method of claim 1, further comprising:
distributing said bookmark.

7. The method of claim 1, further comprising:
determining a mask of allowable user actions.

8. The method of claim 1, wherein said digital content comprises a Blu-ray disc comprising a title authored using BD-J.

9. A method of utilizing a bookmark to access digital content, comprising:
creating a synthetic navigation stream, with reference to said bookmark;
utilizing additional information associated with said bookmark to identify a specific location within said digital content; and
initiating playback of said digital content at said specific location.

10. The method of claim 9, further comprising:
obtaining said bookmark.

11. The method of claim 9, further comprising:
comparing a region access limitation associated with said digital content with a playback device for said digital content, in order to determine whether to allow access to said digital content using said bookmark.

12. The method of claim 9, further comprising:
comparing a region access limitation associated with said digital content with a plurality of playback devices for said digital content, in order to determine whether to allow access to said digital content using said bookmark.

13. The method of claim 9, further comprising:
receiving a user instruction to initiate playback using said bookmark.

14. The method of claim 9, wherein said additional information associated with said bookmark comprises state information associated with a plurality of registers for a playback device.

15. The method of claim 14, further comprising:
applying said state information to said plurality of registers; and
replacing said state information for a subset of said plurality of registers, with reference to user preferences associated with said playback device.

16. The method of claim 9, wherein the creating said synthetic navigation stream comprises:
creating a synthetic index.bdmv file;
creating a synthetic MovieObject.bdmv file; and
placing said synthetic index.bdmv file and said synthetic MovieObject.bdmv file into a memory associated with a playback device.

17. A system for accessing digital content, comprising:
a media server for storing said digital content and a bookmark associated with said digital content; and
a media player, communicatively coupled to said media server and to a display, for retrieving said digital content from said media server and outputting said digital content to said display,
wherein said media player is configured to initiate playback of said digital content utilizing said bookmark by:
creating a synthetic navigation stream, with reference to said bookmark;
utilizing additional information associated with said bookmark to identify a specific location within said digital content; and
initiating playback of said digital content at said specific location.

18. The system of claim 17, wherein said system is communicatively coupled to a head end server, and is configured to retrieve said bookmark from said head end server.

19. The system of claim 17, wherein said digital content is stored on a Blu-ray Disc, comprising a title authored using BD-J.

20. The system of claim 19, wherein said synthetic navigation stream comprises a synthetic HDMV navigation stream.
